(19) United States
(12) Patent Application Publication
(10) Pub. No.: US 2023/0188082 A1
(43) Pub. Date: Jun. 15, 2023

(54) MOBILE INTEGRATED VEHICLE CHARGING AND SHARING PLATFORM

(71) Applicants: Roman M. Kurpas, Hindale, IL (US); Innova EV Inc., Hinsdale, IL (US)

(72) Inventor: Roman M. Kuropas, Hinsdale, IL (US)

(21) Appl. No.: 18/081,329

(22) Filed: Dec. 14, 2022

Related U.S. Application Data
(60) Provisional application No. 63/289,356, filed on Dec. 14, 2021.

(51) Int. Cl. H02S 10/12; H02S 10/40; H02S 10/20; H01M 10/46; B60L 53/30; B60L 53/31

(52) U.S. Cl. CPC H02S 10/12; B60L 53/31; B60L 53/305; H01M 10/465; H02S 10/20; H02S 10/40

(57) ABSTRACT

An integrated mobile solution to electric vehicle charging and sharing without dependency on connection with an electrical power grid or utility. An integrated platform can include a platform housing secured to a transport base unit that is configured to facilitate transport of the integral platform among a road or other terrain. The integrated platform includes a plurality of renewable energy units that can generate electrical power from one or more renewable energy sources, including solar and wind power. Electrical power generated by the renewable energy units can be stored in one or more batteries, and selectively provide power for charging electric vehicles, as well as for components of the integral platform used for vehicle sharing services. An environmental sensing unit of the integrated platform can sense outside ambient conditions which can be transmitted from the integrated platform for sharing or use by other parties or applications.

### FIELD OF INVENTION

The present application relates to a vehicle charging and sharing platform, and more particularly to an integrated mobile solution to electric vehicle charging and sharing without dependency on a connection to an electrical power grid or utility.

### BACKGROUND

Engines or motors of electric vehicles are traditionally at least partially powered by electrical energy that is stored in one or more batteries of the vehicle. Such batteries of electric vehicles can typically require at least periodic recharging, which is often performed at a charging station. Accordingly, the use of electric vehicles can, at least in part, be dependent on the accessibly of the vehicle to such charging stations. However, charging stations are usually electrically coupled to the power grid and/or a municipal utility power source. Yet, certain locations, including, for example, rural and/or desolate areas, may not include infrastructure that can accommodate access to such sources of electrical power. Additionally, developing the infrastructure to accommodate at least the charging of electric vehicles can, in at least certain locations, be timely and cost prohibitive. Further, in some circumstances, the need for such access to electrical power for at least purposes of charging electric vehicles can be relatively temporary or non-permanent, thereby further making the development of the necessary infrastructure cost prohibitive.

### BRIEF SUMMARY

An aspect of an embodiment of the present application is an apparatus comprising a mobile transport base unit having one or more transport bodies, the one or more transport bodies configured to accommodate moveable transport of the mobile transport base unit along a surface or terrain located at least beneath the one or more transport bodies. The apparatus can further include a platform housing that is mountable to the mobile transport base unit, the platform housing having a plurality of sidewalls, the plurality of sidewalls defining an interior region of the platform housing. A plurality of renewable energy units can be secured to the platform housing, and adapted to generate an electrical power from a renewable energy source. At least one of the plurality of renewable energy units can be a different type of renewable energy unit than another renewable energy unit of the plurality of renewable energy units. The apparatus can also include one or more batteries that can be housed within the interior region and electrically coupled to the plurality of renewable energy units. A vehicle charging interface can be electrically coupled to at least one of the_plurality of renewable energy units and the one or more batteries, and can be adapted to be electrically coupled to a charging unit of an electric vehicle. The apparatus can also include an environmental sensor unit comprising a plurality of sensors. Each sensor of the plurality of sensors can be adapted to sense a different condition of an ambient environment outside of the apparatus. Additionally, the apparatus can include a controller having a processor and a memory. The controller can be adapted to issue commands to control a flow of electrical power generated by the plurality of renewable energy units to the one or more batteries, and control a supply of electrical power from the one or more batteries to the vehicle charging interface. Further, the apparatus can include a communication interface that can be communicatively coupled to the controller. The communication interface can be configured to transmit information derived from the environmental sensor unit from the apparatus and to at least one of a cloud computing platform, a remote database, and an external device.

An aspect of an embodiment of the present application is an apparatus comprising a transport base unit having a plurality of transport bodies. The transport bodies can comprise at least one of a wheel, a tire, a tank tread, a caterpillar track, a belt, or a rail. A platform housing can be mountable to the transport base unit, and can include an interior region. The apparatus can also include a first renewable energy unit and a second renewable energy unit, the first renewable energy unit comprising one or more solar panels, and the second renewable energy unit comprising one or more wind turbines. Further, one or more batteries can be housed within the interior region, and be electrically coupled to the first renewable energy unit and the second renewable energy unit. The apparatus can also include a vehicle charging interface that is electrically coupled to at least one of the one or more batteries. The vehicle charging interface can have a connector structured to mate, and be electrically coupled to, a charging connector of an electric vehicle. The vehicle charging interface can be structured for selective delivery of electrical power from the one or more batteries to the electric vehicle. The apparatus can also include an environmental sensor unit comprising a plurality of sensors. Each of the plurality of sensors can be adapted to sense a different condition of an ambient environment outside of the platform housing. Further, a controller can be adapted to issue commands to control a flow of an electrical power generated by the first and second renewable energy units to the batteries, and control a supply of electrical power from the one or more batteries to the vehicle charging interface. Additionally, a communication interface can be communicatively coupled to the controller, the communication interface being configured to transmit information derived from the environmental sensor unit from the apparatus and to at least one of a cloud computing platform, a remote database, and an external device.

Another aspect of an embodiment of the present application is a method for operating a vehicle charging and sharing platform. The method can include providing an integrated platform having a platform housing secured to a mobile transportation base unit. The mobile transport base unit can comprise one or more transport bodies that are configured to accommodate moveable transport of the integrated platform along a surface or terrain located at least beneath the one or more transport bodies. Electrical power can be generated from one or more renewable energy sources by a plurality of renewable energy units of the integrated platform. Further, the plurality of renewable energy units can be mounted to the integrated platform. At least one of the plurality of renewable energy units can be a different type of renewable energy unit than another one of the plurality of renewable energy units. Electrical power generated by the one or more renewable energy sources can be stored in one or more batteries of the integrated platform. Further, electrical power stored by the one or more batteries can be delivered to a charging interface of the integrated platform. The charging interface can be adapted to be selectively electrically coupled to an electrical vehicle during at least an operation that charges a battery of the electric vehicle. Additionally, information regarding an ambient environment external to the integrated platform can be sensed and transmitted to at least one of a cloud computing platform, a remote database, and an external device.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a partially exploded side perspective view of an exemplary integrated platform having a plurality of renewable energy units at first, retracted positions according to an illustrated embodiment of the present application.

FIG. 2 illustrates a side perspective view of the exemplary integrated platform shown in FIG. 1 in which the plurality of renewable energy units are at second, extended positions according to an illustrated embodiment of the present application.

FIGS. 3A and 3B illustrate side perspective views of exemplary renewable energy units at retracted and extended positions, respectively, according to an illustrated embodiment of the present application.

FIG. 4 illustrates a block diagram of at least a portion of an exemplary integrated platform according to an illustrated embodiment of the present application.

FIG. 5 illustrates an exemplary environmental sensor unit for an integrated platform according to an illustrated embodiment of the present application.

FIG. 6 illustrates a top view of a portion of an interior region of a platform housing of an exemplary integrated platform according to an illustrated embodiment of the present application.

FIG. 7 illustrates another embodiment of an integrated platform in which an interior area of the integrated platform houses a crop growth system.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

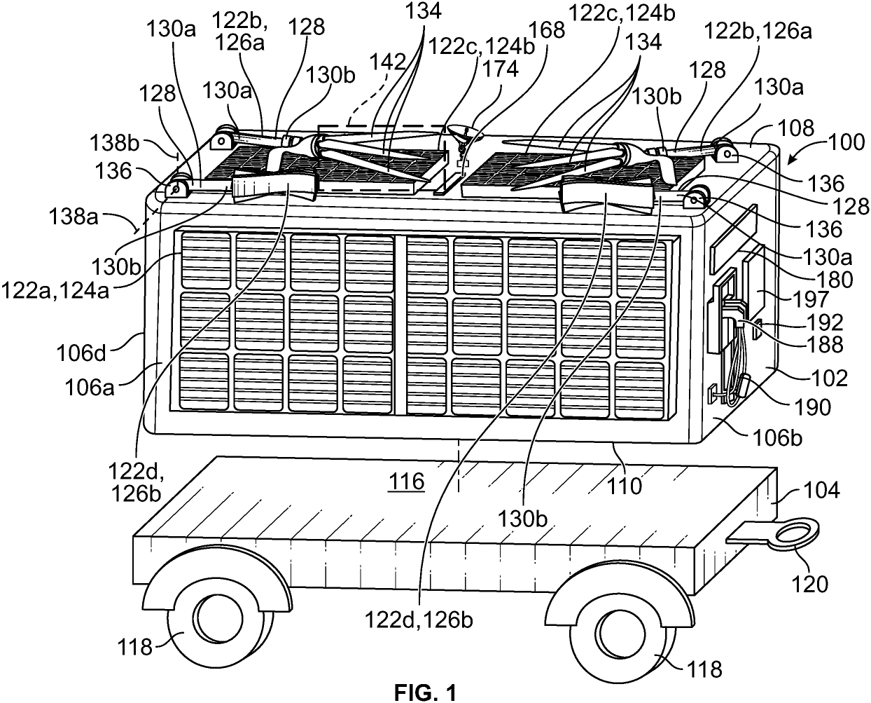

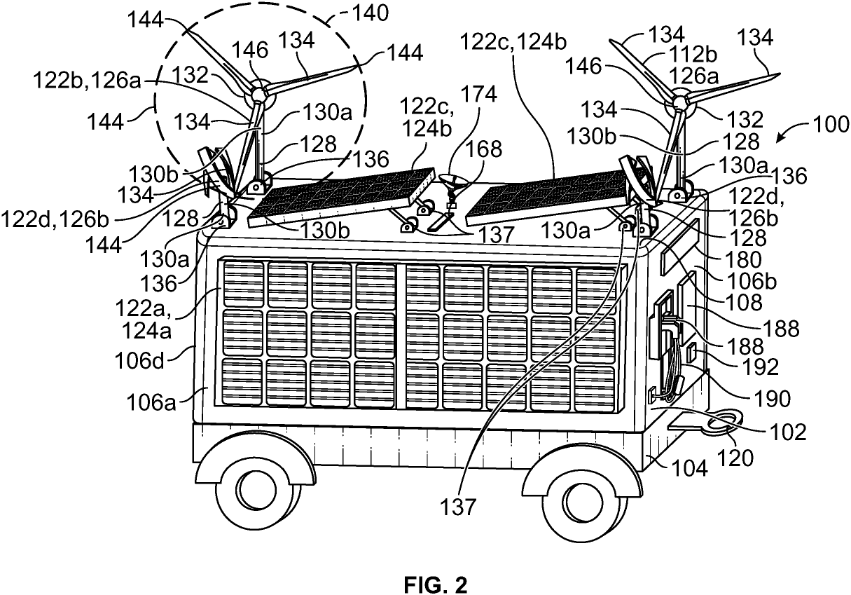

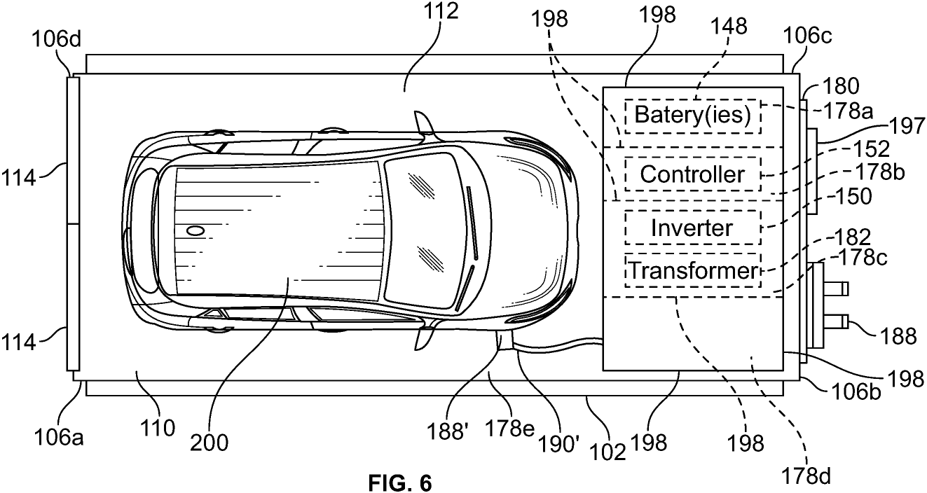

FIGS. 1 and 2 illustrate a partially exploded side perspective view and a side perspective view, respectively, of an exemplary integrated platform 100 according to an illustrated embodiment of the invention. As illustrated, the integrated platform 100 includes a platform housing 102 that can be securely coupled to and/or integrated with a transport base unit 104. The platform housing 102 can include a plurality of sidewalls 106a-d, a top wall 108, and a bottom wall 110 (FIG. 6) which can at least partially define an interior region 112 (FIG. 6) of the platform housing 102. As illustrated in FIG. 6, at least one sidewall 106d may include one or more doors 114 or other access control gates or barriers that can accommodate selective ingress/egress to/from the interior region 112 of the platform housing 102. The top wall 108 and bottom wall 110 of the platform housing 102 can be positioned at opposite vertical ends of the sidewalls 106a-d. Optionally, in lieu of a bottom wall 110, an upper surface 116 of the transport base unit 104 can be used to assist in enclosing at least a portion of the interior region 112.

The platform housing 102 can be constructed from a variety of materials including, for example, metallic and non-metallic materials and/or composites, among other materials, as well as combinations thereof. Additionally, the platform housing 102 can have a variety of shapes and sizes. The specific configuration for the platform housing 102 can depend on a variety of factors including, for example, an anticipated location and/or use of the integrated platform 100, the number of electric vehicles or size of a fleet of vehicles for which the platform housing 102 is being configured to service, the manner in which the integrated platform 100 can be transported to selected locations, and/or potential storage locations for the integrated platform 100, among other considerations.

The transport base unit 104 can be configured to at least provide features that are utilized in the transport of the integrated platform 100, and/or to provide a moveable foundation or support system for at least the platform housing 102. For example, the transport base unit 104 can include one or more transport bodies 118 such as, for example, wheels, tires, tank treads, caterpillar tracks, belts, sled rails or runners, among other types of transport bodies. Moreover, the transport bodies 118 can be configured to engage the surface of an adjacent ground, surface, and/or road as the integrated platform 100 is moved. Thus, the type of transport body 118 utilized can be at least partially dependent on the terrain on which the integrated platform 100 is transported. For example, according to situations in which the integrated platform 100 is to be transported along a paved road, the transport bodies 118 can include a plurality of wheels or tires, as shown in FIGS. 1 and 2. Alternatively, in situations in which the integrated platform 100 is to be transported to an off-grid location that may lack, or have few roads, the transport base unit 104 can be configured to utilize tank treads, caterpillar tracks, belts, and/or sled rails or runners for one or more, if not all, of the transport bodies 118. Further, according to certain embodiments, the transport base unit 104 can be configured as a watercraft, boat and/or barge, among other types of floatation structures, to accommodate floatation and transport of the platform housing 102 in water.

The platform housing 102 and transport base unit 104 may be constructed to accommodate the platform housing 102 being selectively removable from the transport base unit 104. For example, according to certain embodiments, the platform housing 102 can be a cargo vessel, container, or housing that is adapted for transport via rail or boat while attached, or alternatively detached, from the transport body 118. Thus, according to certain embodiments, the transport base unit 104 can comprise a flatbed, lowboy, step deck, or double drop trailer, among other types of trailers. Alternatively, according to other embodiments, the platform housing 102 and transport body 118 can be integrated together in the form of a generally unitary trailer such as, for example, an at least partially, if not completely, enclosed trailer.

According to certain embodiments, the integrated platform 100 is constructed for coupling or attachment to a motorized vehicle. For example, as shown in FIGS. 1 and 2, the integrated platform 100 can be mechanically coupled to a hitch 120 that is adapted to mate a corresponding hitch that is mounted, coupled, and/or secured to a motorized vehicle such as, for example, a truck, car, tractor, train, and/or boat, among other types of vehicles. Alternatively, or additionally, the integrated platform 100 can be self-motorized. For example, according to certain embodiments, the integrated platform 100 can be a motorized vehicle such as, for example, an electrically and/or petroleum powered vehicle that can be driven to a selected location.

As shown in FIGS. 1 and 2, the integrated platform 100 includes a plurality of renewable energy units 122a-d that are utilized to generate electrical power from a renewable energy source. Moreover, the renewable energy units 122a-d can be constructed to be utilized with one or more types of renewable energy sources including, for example, solar and/or wind applications, among others. Further, at least one of the renewable energy units 122a-d can be configured to harvest a particular type of renewable energy source (i.e., a solar or wind application) that is different from another of the renewable energy units 122a-d. Additionally, or alternatively, according to certain embodiments, different renewable energy units 122a-d can be utilized to harvest energy from the same type of renewable energy source, but the type, configuration, and/or size of the renewable energy units 122a-d can differ, and/or the way the renewable energy units 122a-d harvest energy from the same type of renewable energy source can be different.

The number of renewable energy units 122a-d can vary including, for example, based on the anticipated use of the integrated platform 100 and/or based on the size and/or configuration of the integrated platform 100, among other possible considerations or factors. According to the illustrated exemplary embodiment, the renewable energy units 122a-d can comprise one or more first renewable energy units 122a in the form of solar or photovoltaic (PV) panels that are used in solar power applications, one or more second renewable energy units 122b that are utilized in wind power applications, one or more third renewable energy units 122c that are utilized in solar power applications, and/or one or more fourth renewable energy units 122d that are utilized in wind power applications.

Accordingly, in the illustrated example, the first and third renewable energy units 122a, 122c that are utilized in solar power applications can each comprise one or more solar panels 124a, 124b. While the first and third renewable energy units 122a, 122c can each be used in solar power applications, the solar panels 124a, 124b of the first and third renewable energy units 122a, 122c may, or may not, be the same, such as, for example, in terms of the size, shape, number, configuration, and/or type of solar panel(s) that is being utilized. For example, according to certain embodiments, the solar panel type utilized for the solar panels 124a of the first renewable energy unit 122a can be one or more solar shingles, polycrystalline solar panels, moncrystaline solar panels, or thin film solar panels, among other types of solar panels. The solar panel type for the solar panels 124b of the third renewable energy unit 122c can also be selected from a group that can include one or more solar shingles, polycrystalline solar panels, moncrystaline solar panels, and/or thin film solar panels, among others, but the particular solar panel type(s) used for the third renewable energy unit 122c can be different than the particular solar panel type(s) used for the first renewable energy unit 122a.

In addition to, or in lieu of, being different types of solar panels, the first and third renewable energy units 122a, 122c can be positioned at different locations along the integrated platform 100 including, for example, at different locations along the platform housing 102. For example, as shown in FIGS. 1 and 2, according to certain embodiments, the first renewable energy unit(s) 122a can be positioned along one or more sidewalls 106a-d of the platform housing 102, while the third renewable energy unit(s) 122c can be positioned along the top wall 108 of the platform housing 102. However, according to other embodiments, one or both of the first and third renewable energy unit(s) 122a, 122c can be positioned along a combination of one or more of the sidewalls 106a-d and/or the top wall 108. Further, one or both of the first and third renewable energy unit(s) 122a, 122c can be position at a variety of locations along the integrated platform 100 including, but not limited to, from the platform housing 102 and/or the transport base unit 104.

With respect to the second and fourth renewable energy units 122b, 122d, as mentioned above, accordingly to the illustrated example, the second and fourth renewable energy units 122b, 122d can be utilized in wind power applications. Thus, the second and fourth renewable energy units 122b, 122d can each comprise a plurality of wind generator turbines (WGT) 126a, 126b. Similar to the first and third renewable energy unit(s) 122a, 122c, while the second and fourth renewable energy units 122b, 122d can each be used in wind power applications, the second and fourth renewable energy units 122b, 122d may, or may not, be the same, such as, for example, in terms of the size, shape, number, configuration, and/or type of wind turbine(s) that is/are being utilized. For example, as shown in FIG. 2, according to certain embodiments, the second renewable energy unit 122b can comprise one or more horizontal-axis wind turbines 126a, while the fourth renewable energy unit 122b can comprise one or more vertical-axis wind turbines 126b. According to other embodiments, the second and fourth renewable energy units 122b, 122d can each comprise horizontal-axis wind turbine(s) 126a and/or a vertical axis wind turbine(s) 126b, but have wind turbines of different sizes, shapes, configurations, and/or locations.

In addition to wind turbines of different types, the second and fourth renewable energy units 122b, 122d can be positioned at different locations along the integrated platform 100 including, for example, at different locations along the platform housing 102. For example, as shown in FIGS. 1 and 2, according to certain embodiments, the second and fourth renewable energy units 122b, 122d are both positioned along the top wall 108 of the platform housing 102. However, according to other embodiments, one or both of the second and fourth renewable energy units 122b, 122d can be positioned along one or more of the sidewalls 106a-d or the top wall 108, as well as combinations thereof. Further, one or both of the second and fourth renewable energy units 122b, 122d can be positioned at a variety of locations along the integrated platform 100 including, but not limited to, from the platform housing 102 and/or the transport base unit 104.

At least some of the renewable energy units 122a-d can be coupled to the integrated platform 100 in a manner that can accommodate the renewable energy units 122a-d being displaced between a retracted position and an extended position. The retracted position can be configured to at least prevent or minimize the renewable energy units 122a-d from interfering with, and/or being damaged during, the transportation of the integrated platform 100. For example, with respect to at least the second, third, and fourth renewable energy units 122b-d, displacing the renewable energy units 122b-d from the extended position (as shown in FIG. 2) to the retracted position (as shown in FIG. 1) can involve the second, third, and fourth renewable energy units 122b-d being moved, or folded, in a direction generally toward the top wall 108 of the platform housing 102. Thus, selective displacement of the renewable energy units 122a-d from the extended position to the retracted position can reduce the distance that the displaced renewable energy unit 122a-d outwardly extends from the associated top wall 108 or sidewall 106a-d of the platform housing 102 as seen, for example, via a comparison of FIGS. 1 and 2.

According to certain embodiments, the second and fourth renewable energy units 122b, 122d can each include a leg or tower 128 having a first end 130a and a second end 130b, the second end 130b being secured, for example, to a housing 132 of the wind turbine 126a, 126b. The housing 132 can house, or be part of, at least a portion of a generator of the wind turbines 126a, 126b, and can be generally adjacent to the blades 134 of the associated wind turbine 126a, 126b. According to certain embodiments, the first end 130a of the leg 128 can be pivotally coupled to the platform housing 102 via a base 136. Moreover, the leg 128 can be coupled to the base 136 to accommodate rotational or pivotal movement of at least the leg 128 relative to the base 136 as the associated wind turbine 126a, 126b is displaced between the extended and retracted positions. Thus, for example, the first end 130a of the leg 128 can be coupled to the base via a hinge more pin that can accommodate pivotal or rotational displacement of the leg 128, and thus the wind turbine 126a, 126b, relative the base 130 and/or the platform housing 102. Additionally, according to certain embodiments, one or more of the bases 130 can be pivotally coupled to the platform housing 102 such that the base 136 can be at least partially rotated or spun relative to the platform housing 102 and/or relative to a sidewall 106a-d or top wall 108 of the platform housing 102 that is adjacent to the base 136. According to certain embodiments, the leg 128, and thus the wind turbine 126a, 126b, can be pivoted or rotated relative to the base 136 along a first axis 138a that is generally perpendicular to a second axis 138b about which the base 136 can be rotated relative to the platform housing 102, as shown in FIG. 1.

As shown in FIG. 1, according to the illustrated embodiment, the bases 136 for each of the second and fourth renewable energy units 122b, 122d can be coupled to the top wall 108 of the platform housing 102. However, the base 136 of one or more, if not all, of the second and/or fourth renewable energy units 122b, 122d can be secured to other portions of the platform housing 102, including, for example, to one or more of the sidewalls 106a-d. According to other embodiments, in addition to, or in lieu of, a base 136 being pivotally coupled to the leg 128, the leg 128 can include a joint between the first and second ends 130a, 130b of the leg 128 such that the second end 130b of the leg 128, as well as portions of the wind turbine secured and/or adjacent to the second end 130b of the leg 128, can be pivotally displaced or folded relative to the first end 130a of the leg 128 to a retracted position while the position of the first end 130a of the leg 128 may remain relatively static relative to the base 136. Additionally, according to other embodiments, one or more of the legs 130a, 130b can be telescopically arranged such that a linear distance between the first and second ends 130a, 130b of the leg 128 can be selectively adjusted, and moreover increased when the leg 128 is moved to the extended position (FIG. 2) and decreased when the leg 128 is displaced to the retracted position.

Referencing FIGS. 1 and 2, according to certain embodiments, the blades 134 of the wind turbines 126a of the second renewable energy units 122b can also be movable relative to at least the housing 132 of the wind turbine 126a to further reduce the space or footprint occupied by the wind turbines 126a. For example, as shown in FIG. 2, when the wind turbines 126a of the second renewable energy units 122b are at the extended position, the blades 134 of the wind turbines 126a can occupy a first area 140 such as, for example, an area that is generally defined by a diameter that extends along the outer tips 144 of the blades 134. This first area 140 can be larger than a second, generally rectangular area 142 (as shown in FIG. 1) that is occupied by the blades 134 when the blades 134 are in a retracted position relative to at least the housing 132. Thus, the blades 134 can be displaced between the extended and retracted positions relative to the housing 132.

The blades 134 can also be moveable between the first and second areas 140, 142 in a variety of different manners. For example, according to certain embodiments, the blades 134 can be pivotally coupled or hinged to a rotor 146 of the generator of the wind turbine 126a, and/or to other portions of same blade 134 such that the blades 134 can be displaced to occupy the smaller second area 142 when the wind turbines 126a are at or moved to the retracted position. Such retraction of the blades 134, in addition to the retraction of the corresponding wind turbine 126a, can further prevent, or minimize, the associated second and/or fourth renewable energy units 122b, 122d from interfering with or being damaged during transport of the integrated platform 100 and/or platform housing 102.

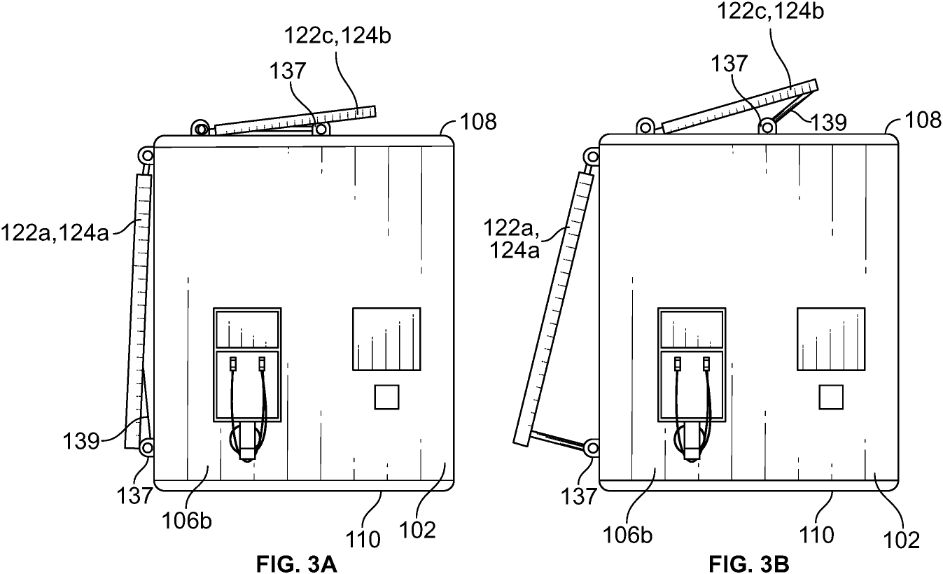

As discussed above, similar to the second and/or fourth renewable energy units 122b, 122d, the first and third renewable energy units 122b, 122d can also be displaced between extended and retracted positions. FIGS. 1, 2, 3A, and 3B illustrate exemplary side perspective views of first and third renewable energy units 122a, 122c at retracted and extended positions, respectively. The direction(s) at which the first and third renewable energy units 122a, 122c outwardly extend can be based on a variety of factors including, for example, the sidewall 106a-d to which the first and/or third renewable energy units 122a, 122c is/are attached, among other considerations. For example, FIGS. 2 and 3B illustrate different examples of extended positions for the third renewable energy units 122c, with the third renewable energy units 122c being shown in FIG. 1 as titled toward the fourth sidewall 106d and tilted toward the first sidewall 106a in FIG. 3B.

According to certain embodiments, at least the third renewable energy unit(s) 122c of the platform housing 102 can be mounted to a base 137 that is rotatable along an axis that is generally perpendicular to the top wall 108 such that the base 137 can be pivoted or rotated about a vertical axis relative to the platform housing 102. According to such an embodiment, the base 137 can be configured as a turntable that can accommodate the third renewable energy unit(s) 122c being selectively oriented, tilted, or directed toward the first sidewall 106a, second sidewall 106b, third sidewall 106c, or fourth sidewall 106d, or alternatively titled to any position therebetween. The base 137 can be secured to an arm 139 that can extend between the base 137 and the associated solar panel 126a, 126b. According to the certain embodiments, opposite ends of the arm 139 can be pivotally coupled to the base 137 and solar panel 126a, 126b such that the arm 139 can be rotated from a retracted position (as shown in FIG. 3A) to an extended position (as shown in FIG. 3B). As shown in FIGS. 3A and 3B, at the extended position, the arm 139 can extend in an outwardly direction further from the platform housing 102 then when the arm 139, and the associated renewable energy source 122a, 122c, is at the retracted position. According to other embodiments, an end of the arm 129 adjacent to the solar panel 126a, 126b can be slide along the solar panel 126a, 126b, such as within a channel of the solar panel 126a, 126b, between a first position that is associated with the retracted position, and a second position that is associated with the extended position. Further, when the arm 126a, 126b is at the retracted position and/or the extended position, the arm 129 may be secured at that particular orientation such as, for example, via insertion of displacement of a locking pin or detent.

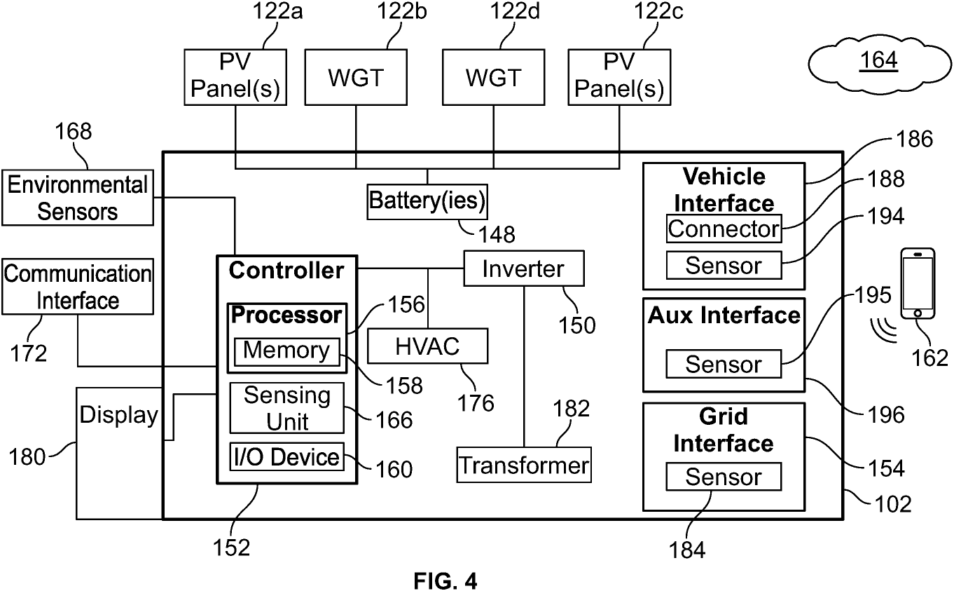

FIG. 4 illustrates a block diagram of at least a portion of an exemplary integrated platform 100 according to an illustrated embodiment of the invention. As discussed above, the renewable energy units 122a-d can be configured to generate an electrical power such as, for example, a direct current (DC) power, via harvesting or generating energy from a renewable energy source. As shown in FIG. 4, power generated by the renewable energy units 122a-d can be stored in one or more batteries 148 of the integrated platform 100 including, for example, a battery stack. Additionally, or alternatively, power generated by the renewable energy units 122a-d and/or power stored in the battery 148 can be delivered to one or more inverters 150 which can, for example, convert DC power to alternating current (AC) power. Moreover, the integrated platform 100 can be configured such that the combination of power generated from the renewable energy units 122a-d, including such generated power that may be stored by the one or more batteries 148 of the integrated platform 100, can provide sufficient power to at least power the integrated platform 100, including the below discussed features of the integrated platform 100, as well as provide electrical power for charging electric vehicles and devices without reliance on power from a power grid or municipal utility power supply.

The integrated platform 100 can also include a controller 152 that can be utilized to control whether power generated by the renewable energy units 122a-d is to be delivered to the batteries 148, an inverter 150, and/or other components of the integrated platform 100. For example, according to certain embodiments, the controller 152 can monitor the level of power being, or anticipated to be, generated by renewable energy units 122a-d, the level of power stored in the batteries 148, and/or the actual or anticipated level of power being used and/or being provided by the integrated platform 100. Using such information, the controller 152 can operate one or more switches to control the flow of electrical power from the renewable energy units 122a-d and/or to/from the batteries 148. Moreover, in some instances, based on an amount or quantity of electrical power being generated by one or more of the renewable energy units 122a-d, the quantity of power that is stored in the batteries 148, and/or the actual or anticipated energy consumption of the integrated platform 100, the controller 152 can determine that power currently being generated by the renewable energy units 122a-d is to be delivered either to the batteries 148 or the inverter 150, or a combination thereof. Alternatively, according to certain embodiments, the controller 152 can be configured to facilitate one or more batteries 148 being charged by the power being generated by one or more of the renewable energy units 122a-d while one or more other batteries 148 are being used to provide power to the inverter 150 that can be used in connection with powering other components of the integrated platform 100, including, for example, the controller 152. Additionally, as discussed below, in situations in which the integrated platform 100 is positioned to be electrically coupled a power grid, the controller 152 can determine whether electrical power from the renewable energy units 122a-d and/or is stored in the batteries 148 is to be provided to the grid via a grid interface 154 of the integrated platform 100.

The controller 152 can include one or more, and any type of, processors 156 capable of performing the functions described herein. In particular, the processor 156 can be embodied as one or more single or multi-core processors, microcontrollers, or other processor or processing/controlling circuits. For example, in some embodiments, the processor 156 can include or be embodied as an arithmetic logic unit (ALU), central processing unit (CPU), digital signal processor (DSP), and/or another suitable processor(s). The processor 156 can be a programmable type, a dedicated hardwired state machine, or a combination thereof. Processors 156 with multiple processing units can utilize distributed, pipelined, and/or parallel processing in various embodiments. Further, the processor 156 can be dedicated to the performance of just the operations described herein, or can be utilized in one or more additional applications. In the illustrative embodiment, the processor 156 is programmable and executes algorithms and/or processes data in accordance with operating logic as defined by programming instructions (such as software or firmware) stored in a memory 158. Additionally, or alternatively, the operating logic can be at least partially defined by hardwired logic or other hardware. Further, the controller 152 can include one or more components of any type suitable to process the signals received from input/output device 160, including, for example, a transceiver of, or electrically coupled to, the controller, or from other components or devices and to provide desired output signals. Such components can include digital circuitry, analog circuitry, or a combination thereof. Moreover, as seen in FIG. 4, such an input/output device 160 can be configured to receive information from, or otherwise exchange communication with, an external device 162, including, but not limited to, a smartphone, tablet, laptop, or other mobile electrical and/or computing devices. Further, as discussed below, the input/output device 160 can also be configured to provide information to, or communication with, other external devices and platforms, including, but not limited to, a cloud computing platform 164.

The memory 158 can be of one or more types of non-transitory computer-readable media, such as a solid-state memory, electromagnetic memory, optical memory, or a combination thereof. Furthermore, the memory 158 can be volatile and/or nonvolatile and, in some embodiments, some or all of the memory 158 can be of a portable type, such as a disk, tape, memory stick, cartridge, and/or other suitable portable memory. In operation, the memory 158 can store various data and software used during operation of the controller 152 and/or processor 156, such as operating systems, applications, programs, libraries, and drivers. It should be appreciated that the memory 158 can store data that is manipulated by the operating logic, such as, for example, data representative of signals received from and/or sent to the input/output device 160 in addition to or in lieu of storing programming instructions defining operating logic. As shown in FIG. 4, the memory 158 can be included with the processor 156 and/or coupled to the processor 156 depending on the particular embodiment. For example, in some embodiments, the processor 156, the memory 158, and/or other components of the controller 152 can form a portion of a system-on-a-chip (SoC) and be incorporated on a single integrated circuit chip.

In some embodiments, various components of the controller 152 (e.g., the processor 156 and the memory 158) can be communicatively coupled via an input/output subsystem, which can be embodied as circuitry and/or components to facilitate input/output operations with the controller 152 and/or memory 158, among other components. For example, the input/output subsystem can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The controller 152 can include other or additional components, such as those commonly found in a typical computing device (e.g., various input/output devices and/or other components). It should be further appreciated that one or more of the components of the controller 152 described herein can be distributed across multiple computing devices. In other words, the techniques described herein may be employed by a computing system that includes one or more computing devices. Additionally, although only a single processor 156, input/output device 160, and memory 158 are illustratively shown in FIG. 4, it should be appreciated that a particular controller 152 may include multiple processors 156, input/output devices 160, and/or memories 158 in other embodiments.

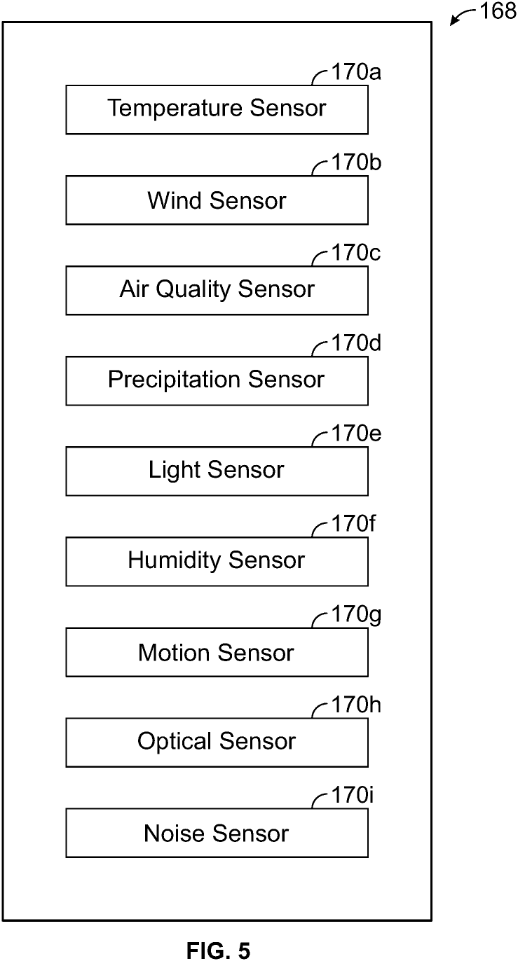

As seen in FIG. 4, the controller 152 can include a sensing unit or module 166 that is communicatively coupled to an environmental sensor unit 168. The sensing unit 166 can be part of, or separate from, the controller 152. Further, the sensing unit 166 can utilize the processor 156, memory 158, and/or input/output device 160 of the controller 152, as previously described, in connection with carrying out features associated with the sensing unit 166 and/or the environmental sensor unit 168. Alternatively, the sensing unit 166 and/or the environmental sensor unit 168 can have components at least similar to the processor 156, memory 158, and/or input/output device 160 of the controller 152 that are generally dedicated to carrying out the features of the sensing unit 166 and/or the environmental sensor unit 168. Further, according to certain embodiments, rather than utilizing the sensing unit 166, the environmental sensor unit 168 can communicate information obtained, determined, and/or derived by the environmental sensor unit 168 to the processor 156 and/or memory 158 of the controller 152. Further, the environmental sensor unit 168 can be coupled to the controller 152, including, for example, the sensing unit 166, via a wired or wireless connection. For example, according to certain embodiments, the controller 152 and/or sensing unit 166 can communicate with the environmental sensor unit 168 and/or one or more sensors 170a-i (FIG. 5) of the environmental sensor unit 168 using an RFID, Bluetooth, or near-field communication protocol, among other types of wireless communication protocols.

FIG. 5 illustrates an exemplary environmental sensor unit 168 for an integrated platform 100 according to an illustrated embodiment of the present application. The environmental sensor unit 168 shown in FIG. 5 is an exemplary depiction, and the environmental sensor unit 168 can be configured to include additional, or fewer sensors 170a-i, as well as at least some sensors 170a-i that are different than those identified in FIG. 5. Additionally, while the environmental sensor unit 168 shown in at least FIG. 1 is at a single location, namely positioned along the top wall 108 of the platform housing 102, the sensors 170a-i of the environmental sensor unit 168 can be positioned at a variety of different locations about the integrated platform 100, as well as at positions that are different than positions at which other sensors of the environmental sensor unit 168 are positioned. For example, one or more of the sensors 170a-i of the environmental sensor unit 168 can be positioned along different sidewalls 106a-d of the platform housing 102, while one or more other sensors 170a-i can be positioned along the top wall 108 of the platform housing 102. Alternatively, according to other embodiments, the sensors 170a-i of the environmental sensor unit 168 can generally be included, including consolidated or bundled together, in a single housing or unit, as generally shown in FIG. 1.

As shown in FIG. 5, the illustrated exemplary environmental sensor unit 168 can include a temperature sensor 170a that can be used in determining an ambient temperature outside of the integrated platform 100. A wind speed sensor 170b of the environmental sensor unit 168 can be used to determine a speed of the wind outside of the integrated platform 100. The environmental sensor unit 168 can also include an air quality sensor 170c that can, for example, monitor gasses, particulate matter, smoke, and/or dust, among other pollutants in the environment outside of the integrated platform 100. The environmental sensor unit 168 can also include a precipitation sensor 170d, light sensor 170e, and/or humidity sensor 170f, which can be used in monitoring or determining the amount and/or type of precipitation, light levels, and water vapor, respectively, in the ambient environment outside of the integrated platform 100. The environmental sensor unit 168 can further include a motion sensor 170g, optical sensor 170h, and/or noise sensor 170i, which can, for example, be used in connection with security of the integrated platform 100. Additionally, or alternatively, the motion sensor 170g, optical sensor 170h, and/or noise sensor 170i can, together or individually, be utilized to awake the controller 152 or other components of the integrated platform 100 from an energy or power saving sleep or hibernation mode.

Information obtained via use of the environmental sensor unit 168 can be utilized in a variety of different manners. For example, according to certain embodiments, the light sensor 170e and/or air quality sensor 170c, among other sensors 170a-i, can provide information used by the controller 152 to determine and/or predict a level of electrical power that may, or may not, be provided via operation of the solar panels 124a, 124b of the first and third renewable energy units 122a, 122c. Similarly, information provided by the wind speed sensor 170b, among other sensors 170a-i, can be utilized in determining and/or predicting a level of electrical power that may, or may not, be provided via operation of the wind turbines 126a, 126b of the second and fourth renewable energy units 122b, 122d. Information obtained by one or more, if not all, of the sensors 170a-i of the environmental sensor unit 168 can also be communicated, such as, for example, by a communication interface 172, to a cloud computing platform 164, remote database, and/or external devices 162, including, for example, mobile devices such as, but not limited to, smartphones, laptops, and tablets, among other mobile electronic devices.

Moreover, the information from one or more sensors 170a-i of the environmental sensor unit 168 that is communicated via the communication interface 172 can be provided or sold to third parties and/or used by applications running on, or available to, the external devices 162. Such information can, in at least certain situations, allow the integrated platform 100 to communicate local environmental information, including weather conditions, at the location of the integrated platform 100. Further, the applications that may obtain access to the information obtained via use of the environmental sensor unit 168 may be dedicated to other services provided by use of the integrated platform 100 including, for example, vehicle sharing and/or electric vehicle charging programs or services. The communication interface 172 can utilize a variety of different types of wired and/or wireless communication protocols, including long range wireless protocols such as, but not limited to, wireless radio technologies, radio waves, and/or microwaves, among other forms of radio communication. Thus,, as shown in FIG. 1, the communication interface 172 can include, among other components, an antenna, transceiver, and/or satellite 174, among other structures utilized to facilitate communications from and/or to the integrated platform 100, including communications from the integrated platform 100 from generally remote, isolated, and/or desolate areas.

Referencing FIG. 4, the controller 152 can also be configured to operate one or more heating and ventilation (HVAC) systems 176 of the integrated platform 100. The HVAC system 176 can include one or more heating and/or cooling units including, for example, an electric heating element, air conditioner, fan(s), vents, and/or dampers, among other types of HVAC components. The HVAC system 176 can be configured to maintain a temperature, or range of temperatures, within the interior region 112 of the platform housing 102. According to certain embodiments, the HVAC system 176 can be configured based on an anticipated area or territory at which the integrated platform 100 may be located. For example, if the integrated platform 100 is anticipated for use in an area that typically experiences relatively high temperatures, the HVAC system 176 can be configured to lower an anticipated temperature within the interior region 112 of the platform housing 102. Moreover, the HVAC system 176 can be configured to maintain a temperature of the interior region 112 of the platform housing 102 that can protect components that can be stored therein, such as, for example, the controller 152 and/or batteries 148, from damage, including damage associated with overheating and/or condensation. Additionally, rather than providing climate control for the entire interior region 112 of the platform housing 102, the interior region 112 can be compartmentalized such as, for example, via one or more walls or barriers 198. The HVAC system 176 can thus be configured to provide climate control for a particular section(s) or subsection(s) 178a-e (FIG. 6) of the interior region 112 including, for example, the particular sections 178a, 178b of the integrated platform 100 in which the batteries 148 and controller 152 are housed. Additionally, according to the illustrated embodiment, the HVAC system 176 can be powered via power generated by one or more of the renewable energy units 122a-d, and/or energy generated by the one or more renewable energy units 122a-d that has been stored in the batteries 148.

The integrated platform 100 can also include one or more displays 180 mounted or otherwise coupled to an exterior side or surface of the platform housing 102, as shown for example in FIG. 1. The images, text, and/or graphics, among other features that can be displayed on the display 180 can be controlled via use of the controller 152. For example, the display 180 can be an electrically powered video board, monitor, and/or a screen onto which information and/or images can be displayed. Further, the display 180 can be powered using power generated by the renewable energy units 122a-d, and/or energy generated by the one or more renewable energy units 122a-d stored in the batteries 148. The display 180 can be used for a variety of different purposes including, but not limited to, providing information regarding the integrated platform 100, services available or provided by the integrated platform 100, environmental conditions, and/or may provide a supplemental source of revenue for the integrated platform 100, such as, via displaying third party advertisements. Additionally, the display 180 can include, or can be operatively coupled to, speakers, which may provide audio associated with the images displayed on the display 180. Information displayed on the display can be provided by a variety of sources including, but not limited to, information stored in the memory 158, information received by the communication interface 172, and/or information received via the input/output device 160, among other sources of information or data for display on the display 180.

Electrical power generated and/or stored by the integrated platform 100 can, when the integrated platform 100 is at a location that can access the power grid, be supplied or sold to the power grid and/or the associated municipal utility supply power source. According to some embodiments, power from the renewable energy units 122a-d and/or batteries 148 is DC power that can be passed through the inverter 150 so that AC power can be supplied to the power grid and/or municipal utility supply power source. Additionally, according to certain embodiments, the integrated platform 100 can further include a transformer 182 such as, for example, a step-up transformer, that is positioned downstream of the inverter 150 and which is utilized to increase the voltage being supplied to the power grid and/or municipal utility supply power source from the integrated platform 100. The integrated platform 100 can include a grid interface 154 configured to provide electrical connections and/or wiring that can facilitate the integrated platform 100 being electrically coupled to the power grid and/or municipal utility supply power source. Further, the grid interface 154, controller 152, or other portion of the integrated platform 100 can include a grid sensor 184 that can track the quantity of electrical power supplied by the integrated platform 100 to the power grid and/or municipal utility supply power source.

The timing and duration of a supply of electrical power from the integrated platform 100 to the power grid can be determined, for example, by the controller 152, and can be based on a variety of factors. Such factors can include, for example, the time of day, amount of electrical power being, or anticipated to be, generated by the renewable energy units 122a-d, an amount of electrical power stored in the batteries 148, the actual or anticipated energy supply needs for operating, or providing services by, the integrated platform 100, and/or the timing of electrical power buy-back programs. The supply of the electrical power to the grid interface 154 can be controlled by the controller 152 issuing commands to at least open and/or close one or more switches, and moreover, the opening and closing of various switches of the integrated platform 100 such that power from the renewable energy units 122a-d and/or batteries 148 be provided to the grid interface 154.

The integrated platform 100 can also include a vehicle interface 186 that can electrically couple an electric vehicle or device to the integrated platform 100 at least for purposes relating to charging one or more batteries of the electric vehicle or device using power provided by the integrated platform 100. As shown in FIG. 1, according to certain embodiments, the vehicle interface 186 can include a charger receptacle or connector 188 that is coupled to a charger cable 190. The charger connector 188 is configured to be electrically coupled to a mating receptacle or connector of an electric vehicle. The charger cable 190 can be used in the delivery of electrical power of the integrated platform 100 to the charger receptacle or connector 188. Further, the charger cable 190 can have a configuration including, for example, a flexibility, that can accommodate displacement of the charger receptacle or connector 188 to a position at which the charger connector 188 can matingly engage the mating or corresponding receptacle or connector of the electric vehicle.

While FIG. 1 illustrates an embodiment in which the vehicle interface 186 includes a charger receptacle or connector 188 and charger cable 190 that are manually displaceable to position the charger receptacle or connector 188 to be electrically coupled to the receptacle or connector of the electric vehicle, the vehicle interface 186 can have a variety of other configurations. For example, according to other embodiments, the vehicle interface 186 can include a platform or arm that can be automatically displaced to a location at which the charger receptacle or connector 188 is electrically coupled to the receptacle or connector of the electric vehicle. Alternatively, or additionally, the vehicle interface 186 can include a docking station to which the electric vehicle or component is placed and/or received so that the charger receptacle or connector 188 is electrically coupled to the corresponding electrical receptacle or connector of the electric vehicle.

The vehicle interface 186 can also include a charger interface 192 which may be part of the input/output device 160. The charger interface 192 can be used to initiate the supply of power from the integrated platform 100, through the vehicle interface 186, to the electric vehicle or component. For example, upon the charger receptacle or connector 188 being electrically coupled to the receptacle or connector of the electric vehicle, a driver of the vehicle, or another individual, can engage the charger interface 192 to indicate that charging of the electric vehicle is to commence. The charger interface 192 can take a variety of forms, including, being one or more of a touch screen, keypad, button, or switch, among other types of input devices. Alternatively, rather than incorporating a charger interface 192, the input/output device 160 of the controller 152 such as, for example, a transceiver, can detect a wireless signal from the external device 160 of the user indicating that a charging process for the electric vehicle is to commence. According to certain embodiments, such communication from the external device 160 to the input/output device 160 of the controller 152 can be facilitated by a software application running on the external device 160 that may, or may not, be dedicated to services provided by at least the integrated platform 100. Alternatively, according to other embodiments, the charging process can commence automatically upon, or after a predetermined after, the controller 152 detects, or receives information indicating, that the charger receptacle or connector 188 is, or has been, electrically coupled to the receptacle or connector of the electric vehicle. As also shown in FIG. 4, the vehicle interface 186 may include a sensor 194 that can monitor or track the quantity of electrical power being supplied though the vehicle interface 186 to the electric vehicle during the charging of the electric vehicle.

According to certain embodiments, the integrated platform 100 can include one or more auxiliary (AUX) interfaces 196 that can be configured for a variety of different purposes. For example, according to certain embodiments, the auxiliary interface 196 can provide an interface for a user to communicate directly with the integrated platform 100 including, for example, communicate with the controller 152 to provide commands, requests, or other information relating to the use of, or services pertaining to, the integrated platform 100. According to such an embodiment, the auxiliary interface 196 can include input/output devices 197 that are part of, or distinct from, the input/output devices 160 of the controller 152. Further, the auxiliary interface 196, or input/output devices 197 associated with the auxiliary interface 196, can be a touchpad, keypad, scanner, card reader, optical reader, and/or RFID reader, among other types of interfaces. Additionally, according to certain embodiments, the auxiliary interface 196 can include a sensor 195 that can be related to security of the integrated platform 100 including, for example, be a biometric recognition system that can be used to identify features of the individual, such as, for example, facial recognition and/or fingerprints. The auxiliary interface 196 can also provide an area at which payment for services rendered relating to the integrated platform 100 can be received, such as, for example, a credit or debit card reader and/or a currency receptacle. Additionally, or alternatively, payment transactions and/or authorization for use of services relating to the integrated platform 100, including vehicle usage and charging, can occur via wireless communications between at least the external device 162 and the integrated platform 100.

FIG. 6 illustrates a top view of a portion of the interior region 112 of a platform housing 102 of an exemplary integrated platform 100 according to an illustrated embodiment of the present application. As previously discussed, the interior region 112 can include one or more interior walls 198 that can be used to generally define a section(s) or subsection(s) 178a-e of the interior region 112. As also previously discussed, such a section(s) 178a-e of the integrated platform 100 can be utilized to house various components of the integrated platform 100 including, but not limited to, electrical components associated with, and including, the controller 152 and/or batteries 148. Further, the interior region 112 can be used for transporting and/or at least temporarily housing various devices or components that can be used with the integrated platform 100 including, for example, an electric vehicle 200. Further, according to certain embodiments, the vehicle interface 186 can be configured to accommodate charging of an electric vehicle 200 that is housed in the interior region 112 of the platform housing 102 including, for example, during transportation of the integrated platform 100. Thus, the vehicle interface 186 can include a charger receptacle or connector 186′ and charger cable 190′ that can be positioned for use within the interior region 112 of the platform housing 102. However, the types of devices or components that can at least temporarily be housed in the interior region 112 can be determined based, at least in part, on the intended use of the integrated platform 100.

The integrated platform 100 can be utilized for a variety of different applications. For example, in at least some instances, the integrated platform 100 can be utilized in connection with vehicle or ride sharing services. According to such embodiments, the integrated platform 100 can provide a possible base location, among other possible base locations, for a vehicle sharing service in which an individual including, for example, an employee or customer, can retrieve, drop-off, and/or charge an electric vehicle. According to certain embodiments, the individual can use an external device 162 to communicate with the controller 152 to check availability of one or more electric vehicles at the integrated platform 100. Such communications between the external device 162 and the controller 152 can, according to certain embodiments, utilize a software application (or “app”) that can be downloaded on the external device 162. Such communications between the external device 162 and the controller 152 can be used to provide authorization for the individual to use the vehicle, such as, for example, authentication and/or payment information being provided by, or through, the external device 162 and communicated to the controller 152. The controller 152 can also be adapted to maintain, and/or communicate to a remote central service or database, information obtained from the external device 162, as well as information regarding the usage and/or location of the electric vehicles.

Upon authorization to use an electric vehicle 200, the controller 152 can communicate information to a software application (“app.”) on the external device 162 that can allow the external device 162 to unlock a door(s) of the electric vehicle such that access can be gained to the interior of the vehicle. Access to the interior of the vehicle can allow access to a key(s) or key fob(s) that is used to at least initiate operation the electric vehicle 200 such as, for example, used to turn on the engine or motor of the vehicle. Alternatively, according to other embodiments, the application can also provide information or signals that can be transmitted from the external device 162 to the electric vehicle 200 that can be used to operate the electric vehicle 200 such as, for example, operate the motor or engine of the electric vehicle 200 such that the vehicle can be driven. The application on the external device 162 can also, according to certain embodiments, interact with the controller 152 and/or the vehicle interface 186 to obtain authorization to commence electrical charging of the electric vehicle 200 using power supplied from one or more of the renewable energy units 122a-d and/or batteries 148, as previously discussed. The app. on the external device 162 can also track a location of the electric vehicle 200 when the electric vehicle 200 is driven away from the integrated platform 100, as well as communicate the return of the electric vehicle 200 to the integrated platform 100.

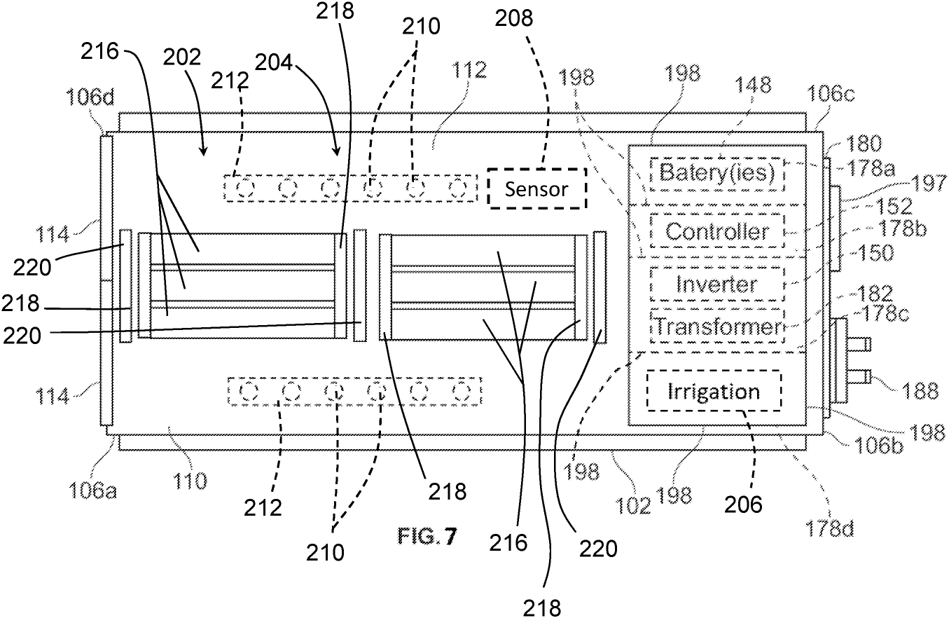

While at least certain embodiments discussed above are directed to the platform housing 102 being configured for use of the integrated platform 100 at least in connection with vehicle sharing and/or electric vehicle charging programs or services, the platform housing 102 can also be configured for additional, or alternative, programs or services. For example, as seen in FIG. 7, according to certain embodiments, the interior region 112 of the platform housing 102 can be configured to house a crop growth system 202, including, but not limited to, a farming system or plant growth system. Moreover, the interior region 112 can be configured to provide an environment that can be used to grow or cultivate one or more types of crops or plants (collectively referred to herein as crops) within the interior region 112, including, but not limited to, crops for human consumption.

According to certain embodiments, the crop growth system 202 can include within the interior region 112 of the platform housing 102 a light system 204, at least a portion of an irrigation system 206, and interior sensors 208. Additionally, the crop growth system 202 can utilize the above-discussed HVAC system 176 to maintain a temperature, or range of temperatures, within the interior region 112 of the platform housing 102, as well as in connection with providing air circulation within the interior region 112. Operation of the light, interior sensor, irrigation, and HVAC systems 204, 208, 206, 176 can be controlled via operation of the controller 152. According to certain embodiments, the controller 152 can utilize one or more preset programs to operate the various systems 204, 208, 206, 176 and components of the crop growth system 202. Further, such programs can be based on the type of crops being grown and/or the ambient environment outside of the integrated platform 100. Additionally, the controller 152 can be adapted to control the operation of the crop growth system 202, or components thereof, based, at least in part, on settings that are manually inputted by one or more operators of the crop growth system 202.

The crop growth system 202 can be powered using electricity generated or harvested by the integrated platform 100, including, for example, via electrical power generated from the operation of solar panels 122a, 122b, 124a, 124b and/or wind turbines 126a, 126b. Electrical power for the operation of the crop growth system 202 can also be provided by power stored in the one or more batteries 148.

The light system 204 can comprise one or more lights 210 and associated light fixtures 212. Various types of lights 210, and combinations of lights 210, can be utilized, including fluorescent, incandescent, and light emitting diodes (LED), among others. Additionally, lights 210 can be selected on the basis of the color and/or wavelength of the associated emitted light, among other criteria. The lights 210 or light fixtures 212 can also be adapted to accommodate selective control of the intensity of the light emitted from the lights 210. According to certain embodiments, the light fixtures 212 to which the lights 210 are coupled to, and which are utilized in the transmission of electrical power to the lights 210, can be positioned at a variety of locations within the interior region 112.

According to certain embodiments, one or more types of crops can be contained in one or more storage containers 216, including crops for human consumption, such as, but not limited to, tomatoes, carrots, beans, potatoes, herbs, and spices, among others. Further, the crops can comprise crops that have been grown from seeds planted in the storage containers 216, or pre-grown crops that were subsequently transplanted into the storage containers 216, as well as combinations thereof. Further, according to certain embodiments, the plurality of the storage containers 216 can be arranged to maximize the storage space within the interior region 112, including arranged in a generally vertically stacked arrangement. Moreover, a plurality of storage containers 216 can coupled to at least one of a plurality of racks or conveyors 218 within the interior region 112, the racks or conveyors 218 configured to at least periodically adjust a vertical position of the storage containers 216. Thus, according to certain embodiments, the racks or conveyors 218 can include an actuator that at least periodically provide a force used to displace the storage containers 216, such as, for example, displace the storage containers 216 in at least a vertical direction. Such displacement of the storage containers 216 can be arranged so as to adjust the positon of the storage containers 216 relative to the lights 210 and/or the locations at which water is dispensed to the storage containers 216 from the irrigation system 206. The storage containers 216 can further be selectively removable from the interior region 112 and/or the racks or conveyors 218. Such a configuration can, for example, accommodate selective periodic replacement of storage containers 216 with other storage containers 216.

The interior sensors 208 are adapted to communicate a plurality of information to the controller 154 regarding at least the environment within the interior region 112, and moreover, regarding the portion of the interior region 112 occupied by the crops. For example, the interior sensors 208 can comprise one or more sensors that may sense similar, or different, environmental attributes of the interior region 112, and/or the medium in which the crops are situated. For example, according to certain embodiments, the interior sensors 208 can provide information regarding the humidity, temperature, brightness of the ambient environment within the portion of the interior region 112 containing crops and/or the moisture content of the medium, such as soil, in which the crops are planted. The controller 152 can utilize such information in connection with monitoring the associated environment, determining whether the change an operation of an associated system, such as, for example, the light, irrigation, or HVAC systems 204, 206, 176, and/or to determine a potential malfunction in the operation of at least such systems 204, 206, 176.

The irrigation system 206 can be adapted to dispense water to the crops positioned within the interior region 112, including within the storage containers 216. According to certain embodiments, the irrigation system 206 can be coupled to a water source, such as, for example, a municipal water supply. Additionally, or alternatively, the irrigation system 206 can include a water tank or reservoir that can store water that is to be supplied to the crops. The water can be dispensed, such as, for example, via operation of an associated pump, to the crops in a variety of different manners, including, for example, being outputted through a hose, nozzle, and/or sprayer. For purposes of discussion, FIG. 7 illustrates a plurality of towers 220 from which water can be sprayed onto the crops.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law.

Furthermore, it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An apparatus, comprising:
a mobile transport base unit comprising one or more transport bodies configured to accommodate moveable transport of along a surface or terrain;
a platform housing mountable to the mobile transport base unit and having a plurality of sidewalls;
a plurality of renewable energy units secured to the platform housing and adapted to generate electrical power from a renewable energy source, at least two of the plurality of renewable energy units being of different types;
one or more batteries electrically coupled to the plurality of renewable energy units;
a vehicle charging interface electrically coupled to at least one of the-plurality of renewable energy units and the one or more batteries, and adapted to be electrically coupled to a charging unit of an electric vehicle;
an environmental sensor unit comprising a plurality of sensors, each sensor of the plurality of sensors adapted to sense a different condition of an ambient environment outside of the apparatus;
a controller having a processor and a memory, the controller adapted to issue commands to control a flow of electrical power generated by the plurality of renewable energy units to the one or more batteries, and control a supply of electrical power from the one or more batteries to the vehicle charging interface; and
a communication interface communicatively coupled to the controller and configured to transmit information derived from the environmental sensor unit from the apparatus and to at least one of a cloud computing platform, a remote database, or an external device.

2. The apparatus of claim 1, wherein the plurality of renewable energy units are adapted to harvest solar energy, the plurality of renewable energy units comprising a plurality of solar panels, wherein at least some of the plurality of solar panels differ from another of the plurality of solar panels with respect to at least one of a solar panel type, a size, or a vertical mounting position on the platform housing.

3. The apparatus of claim 2, wherein the plurality of renewable energy units further comprise a plurality of wind turbines, wherein one or more of the plurality of wind turbines is a horizontal-axis wind turbine or a vertical-axis wind turbine.

4. The apparatus of claim 1, wherein the plurality of renewable energy units are configured for selective displacement between a retracted position and an extended position, at least a portion of the plurality of renewable energy units extending from the platform housing by a first distance when at the retracted position, and by a second distance when at the extended position, the second distance being greater than the first distance.

5. The apparatus of claim 1, wherein the renewable energy units are pivotally coupled to the platform housing.

6. The apparatus of claim 1, further including a display mounted to an exterior side of at least one of the plurality of sidewalls of the platform housing.

7. The apparatus of claim 1, wherein the plurality of renewable energy units include at least one wind turbine having a plurality of blades coupled to a rotor, one or more of the blades being inwardly displaceable from a first position to a second position, and where a footprint of the plurality of blades is reduced by a displacement of the plurality of blades from the first position to the second position.

8. The apparatus of claim 1, wherein the vehicle charging interface comprises a connector coupled to a charger cable, the connector being adapted to mate and be electrically coupled to a charging connector of the electric vehicle.

9. The apparatus of claim 1, wherein the transport bodies comprise at least one of the following: a wheel, a tire, a tank tread, a caterpillar track, a belt, or a rail.

10. An apparatus, comprising:
a transport base unit having a plurality of transport bodies, the transport bodies comprising at least one of the following: a wheel, a tire, a tank tread, a caterpillar track, a belt, or a rail;
a platform housing mountable to the transport base unit;
a first renewable energy unit and a second renewable energy unit, the first renewable energy unit comprising one or more solar panels, the second renewable energy unit comprising one or more wind turbines;
one or more batteries electrically coupled to the first renewable energy unit and the second renewable energy unit;
a vehicle charging interface electrically coupled to at least one of the one or more batteries, the vehicle charging interface having a connector structured to mate with and be electrically coupled to a charging connector of an electric vehicle, the vehicle charging interface structured for selective delivery of electrical power from the one or more batteries to the electric vehicle;
an environmental sensor unit comprising a plurality of sensors, each of the plurality of sensors adapted to sense a different condition of an ambient environment outside of the platform housing;
a controller adapted to issue commands to control a flow of an electrical power generated by the first and second renewable energy units to the batteries, and control a supply of electrical power from the one or more batteries to the vehicle charging interface; and
a communication interface communicatively coupled to the controller and configured to transmit information derived from the environmental sensor unit from the apparatus and to at least one of a cloud computing platform, a remote database, or an external device.

11. The apparatus of claim 10, wherein the plurality of sensors include at least a wind speed sensor, a light sensor, a temperature sensor, or an air quality sensor.

12. The apparatus of claim 10, wherein the one or more wind turbines comprise at least one horizontal-axis wind turbine and at least one vertical-axis wind turbine.

13. The apparatus of claim 12, wherein the one or more wind turbines are selectively displaceable between a retracted position and an extended position.

14. The apparatus of claim 13, wherein the one or more wind turbines are pivotally coupled to the platform housing.

15. The apparatus of claim 10, wherein at least one of the one or more solar panels is different in a size or a solar panel type than another one of the one or more solar panels.

16. The apparatus of claim 10, wherein the one or more wind turbines of the second renewable energy unit and at least one of the one or more solar panels are secured to a top wall of the platform housing, and at least one of the one or more solar panels is mounted to a sidewall of the platform housing.

17. The apparatus of claim 10, further including a display mounted to an exterior side of at least one of a plurality of sidewalls of the platform housing.

18. A method for operating a vehicle charging and sharing platform, the method comprising:
providing an integrated platform having a platform housing secured to a mobile transportation base unit, the mobile transport base unit comprising one or more transport bodies configured to accommodate moveable transport of the integrated platform along a surface or terrain located at least beneath the one or more transport bodies;
generating electrical power from one or more renewable energy sources by a plurality of renewable energy units of the integrated platform, the plurality of renewable energy units mounted to the integrated platform, at least one of the plurality of renewable energy units being of a different type than another of the plurality of renewable energy units;
storing electrical power generated by the one or more renewable energy sources in one or more batteries of the integrated platform;
delivering electrical power stored by the one or more batteries to a charging interface of the integrated platform, the charging interface adapted to be selectively electrically coupled to an electrical vehicle during at least an operation that charges a battery of the electric vehicle;
sensing information regarding an ambient environment external to the integrated platform; and
transmitting the sensed information to at least one of a cloud computing platform, a remote database, and an external device.

19. The method of claim 18, further including displaying information on a display externally mounted to a sidewall of the platform housing.

20. The method of claim 18, further including displacing, relative to the platform housing, the one or more renewable energy sources from a retracted position to an extended position.
